(19) United States
(12) Patent Application Publication
(10) Pub. No.: US 2022/0303985 A1
(43) Pub. Date: Sep. 22, 2022

(54) METHODS FOR COMMUNICATION, DEVICES, AND COMPUTER READABLE MEDIUM

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 17/616,014

(22) PCT Filed: Jun. 6, 2019
(86) PCT No.: PCT/CN2019/090414

§ 371 Date: Dec. 2, 2021

(51) Int. Cl. H04W 72/04; H04L 1/18

(52) U.S. Cl. CPC H04W 72/0446; H04W 72/0406; H04L 1/1887

(57) ABSTRACT

Embodiments of the present disclosure provide a solution for resource reservation for a retransmission in a sidelink channel. In a method for communication, a first device generates data to be transmitted to a second device via a sidelink channel. The first device determines whether a reservation criterion for reserving a retransmission resource for a retransmission of the data is satisfied. The retransmission resource is comprised in a resource pool for sidelink communications of the first device and further devices including the second device. In response to determining that the reservation criterion is satisfied, the first device transmits to the further devices reservation information indicating that the retransmission resource is reserved. With the embodiments of the present disclosure, better resource utilization of a resource pool for sidelink communications enabling resource reservation for feedback based retransmission is achieved.

### FIELD

Embodiments of the present disclosure generally relate to the field of communication, and in particular, to reservation of retransmission resource in sidelink communications.

### BACKGROUND

The latest developments of the 3GPP standards are referred to as Long Term Evolution (LTE) of Evolved Packet Core (EPC) network and Evolved UMTS Terrestrial Radio Access Network (E-UTRAN), also commonly termed as ‘4G.’ In addition, the term ‘5G New Radio (NR)’ refers to an evolving communication technology that is expected to support a variety of applications and services. The 5G NR is part of a continuous mobile broadband evolution promulgated by the Third Generation Partnership Project (3GPP) to meet new requirements associated with latency, reliability, security, scalability (for example, with Internet of Things), and other requirements. Some aspects of the 5G NR may be based on the 4G Long Term Evolution (LTE) standards.

Recently, for sidelink communications in the 5G NR, some agreements are reached as follows. NR V2X (vehicle-to-everything) Mode-2 supports resource reservation for feedback-based physical sidelink shared channel (PSSCH) retransmissions by signaling associated with a prior transmission of the same transport block (TB). The impact on subsequent sensing and resource selection procedures is for future study. At least from the perspective of the transmitter of this TB, usage of hybrid automatic repeat request (HARQ) feedback for release of unused resource(s) is supported. No additional signaling is defined for the purpose of release of unused resources by the transmitting UE. The behavior of the receiver UE(s) of this TB and the behavior of other UEs are for future study.

### SUMMARY

In general, example embodiments of the present disclosure provide a solution for resource reservation for a retransmission in a sidelink channel.

In a first aspect, there is provided a method for communication. The method comprises generating, at a first device, data to be transmitted to a second device via a sidelink channel. The method also comprises determining whether a reservation criterion for reserving a retransmission resource for a retransmission of the data is satisfied, the retransmission resource being comprised in a resource pool for sidelink communications of the first device and further devices including the second device. The method further comprises in response to determining that the reservation criterion is satisfied, transmitting to the further devices reservation information indicating that the retransmission resource is reserved.

In a second aspect, there is provided a method for communication. The method comprises receiving, from a first device and at a second device, reservation information indicating that a retransmission resource is reserved for a retransmission of data from the first device to the second device via a sidelink channel, the retransmission resource being comprised in a resource pool for sidelink communications of the second device and further devices including the first device. The method also comprises determining availability of the retransmission resource for a sidelink transmission to at least one of the further devices including the first device. The method further comprises selecting a transmission resource for the sidelink transmission from the resource pool, based on the availability of the retransmission resource.

In a third aspect, there is provided a method for communication. The method comprises receiving, at a third device, from a first device in a sidelink communication with a second device, reservation information indicating that a retransmission resource is reserved for a retransmission from the first device to the second device via a sidelink channel, the retransmission resource being comprised in a resource pool for sidelink communications of the third device and further devices including the first device and the second device. The method also comprises monitoring an ACK/NACK channel from the second device to the first device. The method also comprises determining availability of the retransmission resource for a sidelink transmission to at least one of the further devices including the first device and the second device, based on a result of the monitoring. The method further comprises selecting a transmission resource for the sidelink transmission from the resource pool, based on the availability of the retransmission resource.

In a fourth aspect, there is provided a first device. The first device comprises a processor and a memory storing instructions. The memory and the instructions are configured, with the processor, to cause the first device to perform the method according to the first aspect.

In a fifth aspect, there is provided a second device. The second device comprises a processor and a memory storing instructions. The memory and the instructions are configured, with the processor, to cause the second device to perform the method according to the second aspect.

In a sixth aspect, there is provided a third device. The third device comprises a processor and a memory storing instructions. The memory and the instructions are configured, with the processor, to cause the third device to perform the method according to the third aspect.

In a seventh aspect, there is provided a computer readable medium having instructions stored thereon. The instructions, when executed on at least one processor of a device, cause the device to perform the method according to the first aspect, the second aspect, or the third aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which some embodiments of the present disclosure can be implemented;

FIG. 2 shows a flowchart of an example method in accordance with some embodiments of the present disclosure;

FIG. 3 shows a schematic diagram of a resource pool comprising resources for sidelink communications among terminal devices in accordance with some embodiments of the present disclosure;

FIG. 4 shows a flowchart of another example method in accordance with some embodiments of the present disclosure;

FIG. 5 shows a flowchart of a further example method in accordance with some embodiments of the present disclosure; and

FIG. 6 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communication. Examples of a network device include, but not limited to, a Node B (NodeB or NB), an Evolved NodeB (eNodeB or eNB), a next generation NodeB (gNB), an infrastructure device for a V2X communication, a Transmission/Reception Point (TRP), a Remote Radio Unit (RRU), a radio head (RH), a remote radio head (RRH), a low power node such as a femto node, a pico node, and the like.

As used herein, the term “terminal device” refers to any device having wireless or wired communication capabilities. Examples of the terminal device include, but not limited to, user equipment (UE), vehicle-mounted terminal devices, devices of pedestrians, roadside units, personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UEs as examples of terminal devices and the terms “terminal device” and “user equipment” (UE) may be used interchangeably in the context of the present disclosure.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

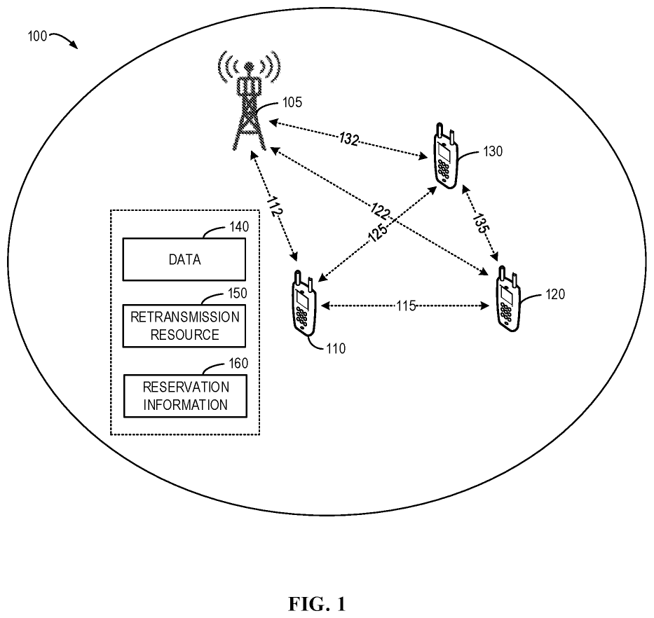

FIG. 1 is a schematic diagram of a communication environment 100 in which some embodiments of the present disclosure can be implemented. As shown in FIG. 1, a first device 110, a second device 120, and a third device 130 are in coverage of a fourth device 105. In other words, the fourth device 105 may serve the first device 110, the second device 120, and the third device 130, and can provide wireless connections for them. In particular, the first device 110 may communicate with the fourth device 105 via a communication channel 112, the second device 120 may communicate with the fourth device 105 via a communication channel 122, and the third device 130 may communicate with the fourth device 105 via a communication channel 132.

For transmissions from the fourth device 105 to the first device 110, the second device 120 or the third device 130, the communication channel 112, 122, or 132 may be referred to as a downlink channel, whereas for transmissions from the first device 110, the second device 120, or the third device 130 to the fourth device 105, the communication channel 112, 122, or 132 may alternatively be referred to as an uplink channel. Additionally, the first device 110 may communicate with the second device 120 via a device-to-device (D2D) channel, which may also be referred to as a sidelink channel 115. Similarly, the first device 110 may communicate with the third device 130 via a sidelink channel 125, and the second device 120 may communicate with the third device 130 via a sidelink channel 135. In some cases, the fourth device 105 may be absent in the communication environment 100. For example, the first device 110, the second device 120, and the third device 130 are out of the coverage of the fourth device 105. In such cases, only sidelink communications exist among the first device 110, the second device 120, and the third device 130 as well as possibly other terminal devices not shown in FIG. 1.

In some embodiments, the first device 110, the second device 120, and the third device 130 as well as possibly other devices may share a same resource pool for performing sidelink transmissions among these devices. In the case that multiple devices are to perform respective sidelink transmissions at same time, there is a possibility that more than one device selects a same transmission resource in the resource pool for their sidelink transmissions, especially when a congestion level (also termed as congestion status, for example, channel reservation, CR, or channel busy rate, CBR) associated with the resource pool is high. In other words, if the first device 110 is selecting a transmission resource from the resource pool to perform a sidelink transmission, a selection collision of the transmission resource may occur between the first device 110 and other devices which are also selecting this transmission resource to perform their sidelink transmissions.

As used herein, the term “resource,” “transmission resource,” or “sidelink resource” may refer to any resource for performing a communication, for example, a sidelink communication, such as a resource in time domain, a resource in frequency domain, a resource in space domain, a resource in code domain, or any other resource enabling a communication, and the like. Accordingly, the term “resource pool” may refer to a set of resource units in time domain (for example, time slots), in frequency domain (for example, sub-channels), in space domain, in code domain, and the like. In the following, a resource in both frequency domain and time domain will be used as an example of a sidelink resource for describing some embodiments of the present disclosure. It is noted that embodiments of the present disclosure are equally applicable to other resources in other domains.

In an example scenario of a sidelink transmission, the first device 110 may transmit data 140 via the sidelink channel 115 to the second device 120. In some embodiments, the data 140 may be transmitted via a unicast transmission, in which the second device 120 is the only intended receiving device (also termed as a destination device). In some other embodiments, the data 140 can be transmitted via a groupcast transmission, in which the second device 120 is one of a group of intended receiving devices. In some further embodiments, the data 140 may be transmitted via a broadcast transmission or any other suitable transmission manners. As used herein, the data 140 may include any data that can be transmitted via a sidelink channel, including user plane data, control plane data, or the like. For example, the data 140 may be a TB or a packet.

For the data 140 transmitted from the first device 110, the second device 120 as a receiving device can provide to the first device 110 a feedback (such as a HARQ feedback) indicating whether the data 140 is successfully received by the second device 120 or not. If the data 140 is successfully received by the second device 120, the second device 120 may provide a positive feedback (also termed as an acknowledgement, ACK for short) to the first device 110. On the contrary, if the data 140 is unsuccessfully received by the second device 120, the second device 120 may provide a negative feedback (also termed as a negative acknowledgement, NACK for short) to the first device 110. As used herein, a communication channel for providing such a feedback may be referred to as an ACK/NACK channel. Similarly, if the data 140 is transmitted via a groupcast transmission, other receiving devices of the group of intended receiving devices may also transmit respective feedbacks to the first device 110 via respective ACK/NACK channels.

In the following, the physical sidelink feedback channel (PSFCH) may be used as an example of an ACK/NACK channel. In general, the PSFCH is defined in recent agreements in a meeting of 3GPP and it is supported to convey sidelink feedback control information (SFCI) for unicast and groupcast via a PSFCH. However, it is to be understood that the ACK/NACK channel as used herein is not limited to the PSFCH, but may refer to any suitable channel for a device to provide a positive feedback or a negative feedback for data transmitted by another device.

In addition, in some embodiments, for transmitting a positive feedback or a negative feedback in a sidelink communication, a receiving device may employ one of two different ACK/NACK transmission modes. The first ACK/NACK transmission mode may also be referred to as option 1 for HARQ feedbacks, in which no signal in an ACK/NACK channel indicates a successful reception by a receiving device. The second ACK/NACK transmission mode may also be referred to as option 2 for HARQ feedbacks, in which an ACK in an ACK/NACK channel indicates a successful reception by a receiving device.

In particular, regarding the option 1 and option 2 for HARQ feedbacks, some agreements are reached as follows. For the option 1, a receiver UE transmits a HARQ-NACK on the PSFCH if it fails to decode the corresponding TB after decoding the associated physical sidelink control channel (PSCCH). It transmits no signal on the PSFCH otherwise. For the option 2, a receiver UE transmits a HARQ-ACK on the PSFCH if it successfully decodes the corresponding TB. It transmits a HARQ-NACK on the PSFCH if it does not successfully decode the corresponding TB after decoding the associated PSCCH which targets the receiver UE. Although two ACK/NACK transmission modes are described above as examples, it is understood that embodiments of the present disclosure are equally applicable to other existing or future ACK/NACK transmission modes.

If the first device 110 receives a NACK from the second device 120 (in the case of a unicast transmission) or from any receiving device of the group of intended receiving devices (in the case of a groupcast transmission), the first device 110 may need to retransmit the data 140 using a retransmission resource 150 selected from the resource pool. In order to avoid a possible collision in selecting the retransmission resource 150 with other devices which are also selecting the retransmission resource 150 to perform a sidelink transmission, the first device 110 can reserve the retransmission resource 150 in advance, for example, at the time when the transmission resource for the initial transmission of the data 140 is selected from the resource pool or by signaling associated with a prior transmission of the data 140.

The reservation of the retransmission resource 150 by the first device 110 can be informed to other devices sharing the same resource pool through reservation information 160. It is noted that these other devices also include the second device 120 and the third device 130. The reservation information 160 may indicate that the retransmission resource 150 is reserved by the first device 110 for a potential retransmission of the data 140. With the reservation of the retransmission resource 150, if the first device 110 receives a NACK for the data 140, the first device 110 can use the retransmission resource 150 to retransmit the data 140, instead of selecting again an available resource after the first device 110 determines to retransmit the data 140. If the first device 110 does not receive a NACK from any receiving device, the first device 110 does not need to retransmit the data 140 and may release the retransmission resource 150, which means that the retransmission resource 150 is available for other sidelink transmissions by other devices as well as by the first device 110 itself

In some embodiments, the first device 110, the second device 120, and the third device 130 may be terminal devices, and the fourth device 105 may be a network device. In some other embodiments, the first, second, and third devices 110, 120, and 130 as well as the fourth device 105 may be any other suitable communication devices, which can communicated with one another. Embodiments of the present disclosure are not limited to the example scenario of FIG. 1. In this regard, it is noted that although the first, second, and third devices 110, 120, and 130 are schematically depicted as mobile phones in FIG. 1, it is understood that this depiction is only for example without suggesting any limitation. In other embodiments, the first, second, and third devices 110, 120, and 130 may be any other wireless communication devices, for example, vehicle-mounted terminal devices.

In case the first, second, and third devices 110, 120, and 130 are vehicle-mounted terminal devices, the communications relate to the first, second, and third devices 110, 120, and 130 may be referred to as V2X communications. More generally, although not shown in FIG. 1, a V2X communication related to the first device 110, the second device 120, or the third device 130 may comprise a communication between the first device 110, the second device 120, or the third device 130 and any other communication device, including but not limited to, an infrastructure device, another vehicle-mounted terminal device, a device of a pedestrian, a roadside unit, or the like. Furthermore, although not shown, all the communication links as shown in FIG. 1 may be via one or more relays.

It is to be understood that the number of communication devices as shown in FIG. 1 are only for the purpose of illustration without suggesting any limitations. The communication environment 100 may include any suitable number of communication devices adapted for implementing embodiments of the present disclosure. In addition, it would be appreciated that there may be various wireless communications as well as wireline communications (if needed) among these additional communication devices.

The communications in the communication environment 100 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As mentioned above, it is agreed that a device in a sidelink communication can reserve a retransmission resource for a potential future retransmission of data by signaling associated with a prior transmission of the same TB. However, there may be some issues with this reservation of retransmission resource. Specifically, a reserved resource may remain unused and thus be wasted if a positive feedback is received by the transmitting device, that is, no retransmission is needed. This problem may be known as an over-booking issue and can result in inefficient resource utilization. According to some simulation results, a probability of HARQ-based retransmission is about only 10%. This means that 90% of the HARQ-based retransmission resources are over-booked and are released either explicitly or implicitly. Therefore, there is a need to mitigate the over-booking issue and to properly handle reserved resources which are unused by the reserving device.

It has been proposed an approach to handle the above over-booking issue. The approach allows a terminal device to select a transmission resource even if the transmission resource is reserved by a further terminal device under a certain condition. The condition may be that a reference signal received power (RSRP) measurement on the transmission resource is below a RSRP threshold, or that the data to be transmitted by the terminal device is more important than the data to be retransmitted by the further terminal device. However, this approach has some drawbacks. For example, in the approach, a transmission resource reserved by a terminal device can be still used by another terminal device due to a low RSRP or priority, which is contrary to the original intention of the reservation of the transmission resource. It would be appropriate that reserved transmission resource(s) should not be occupied by any other terminal device unless no retransmission is needed.

In order to solve the above technical problems and potentially other technical problems in conventional solutions, embodiments of the present disclosure provide a solution for resource reservation for a retransmission in a sidelink channel. The main ideas of the embodiments of the present disclosure are defining behavior of a transmitting device of data when reserving a retransmission resource for a retransmission to avoid unnecessary reservation, and defining behavior of receiver UE(s) of the data and behavior of other UEs to make use of the released resources. With the embodiments of the present disclosure, better resource utilization of a resource pool for sidelink communications enabling resource reservation for feedback based retransmission is achieved. Principles and implementations of the present disclosure will be described in detail below with reference to the figures.

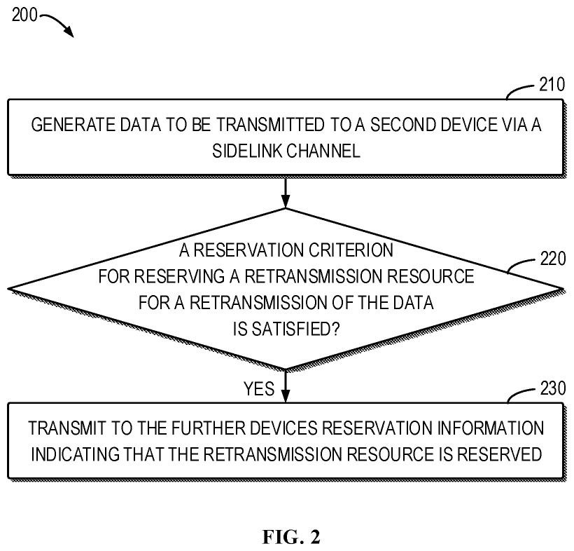

FIG. 2 shows a flowchart of an example method 200 in accordance with some embodiments of the present disclosure. In some embodiments, the method 200 can be implemented at a terminal device, such as the first device 110 as shown in FIG. 1. Additionally or alternatively, the method 200 can also be implemented at other communication devices not shown in FIG. 1. For the purpose of discussion, the method 200 will be described with reference to FIG. 1 as performed by the first device 110 without loss of generality.

At block 210, in a sidelink communication between the first device 110 and the second device 120, the first device 110 generates the data 140 to be transmitted to the second device 120 via the sidelink channel 115. For the initial transmission of the data 140, the first device 110 may select a transmission resource from a resource pool shared by the first device 110 and further devices including the second device 120 and the third device 130. As described above, if the first device 110 receives a NACK from the second device 120 (in the case of a unicast transmission) or from any receiving device of the group of intended receiving devices (in the case of a groupcast transmission), the first device 110 may need to retransmit the data 140 using a retransmission resource 150 selected from the resource pool.

Similarly, for the retransmitted data 140, the second device 120 (in the case of a unicast transmission) or the intended receiving devices (in the case of a groupcast transmission) can provide an ACK/NACK feedback to the first device 110. If the first device 110 receives again a NACK from the second device 120 (in the case of a unicast transmission) or from any receiving device of the group of intended receiving devices (in the case of a groupcast transmission), the first device 110 may need to perform a second retransmission of the data 140 using a second retransmission resource selected from the resource pool. A number of retransmissions of the data 140 can be performed in a similar manner.

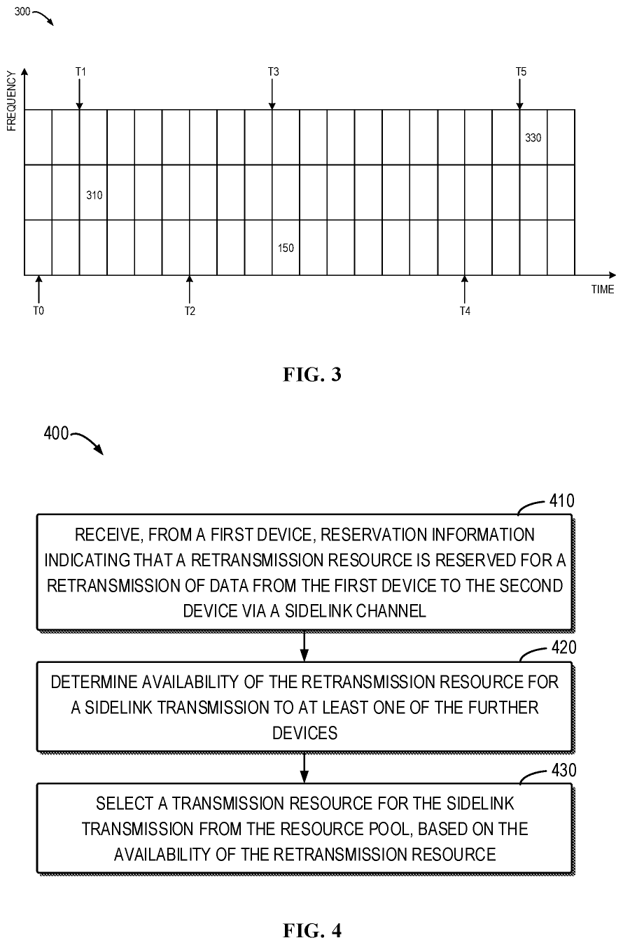

In the following, the above transmission and retransmission procedures will be detailed with reference to an example of a resource pool as shown in FIG. 3. In the description, a unicast transmission of the data 140 may be taken as an example for clarity. However, it is understood that the embodiments of the present disclosure are equally applicable to other transmission manners, including a groupcast transmission.

FIG. 3 shows a schematic diagram of a resource pool 300 comprising resources for sidelink communications among terminal devices in accordance with some embodiments of the present disclosure. In FIG. 3, the horizontal axis represents time, the vertical axis represents frequency, and each of blocks represents a transmission resource for a sidelink transmission. In some embodiments, one block corresponds to a time slot in time domain and a sub-channel in frequency domain. However, it is to be appreciated that one block may correspond to any other suitable time unit in time domain and any other suitable frequency unit in frequency domain.

In the example of FIG. 3, it is assumed that the first device 110 generates the data 140 at a time point T0. Then, the first device 110 may select a transmission resource 310 from the resource pool 300 for transmitting the data 140. The beginning of the transmission resource 310 is at a time point T1. Afterwards, the first device 110 can perform an initial transmission of the data 140 using the transmission resource 310. If the second device 120 fails to successfully receive the data 140, the second device 120 may transmit a NACK in a time point T2.

Upon receiving the NACK from the second device 120, the first device 110 may retransmit the data 140 to the second device 140. In case that the first device 110 does not perform reservation of a retransmission resource, the first device 110 can again select a transmission resource for the retransmission of the data 140 after receiving the NACK from the second device 120. However, since the resource pool 300 is shared by a plurality of devices for performing sidelink transmissions, the earliest available resource for the retransmission may be relative far away from the time point T2. In this event, a delay for transmitting the data 140 may be relatively large, which may be undesirable.

In order to avoid a possible selection collision of the retransmission resource for the retransmission of the data 140, the first device 110 may reserve a retransmission resource for the potential retransmission of the data 140 before the data 140 is initially transmitted, particularly at the same time when the transmission resource 310 is selected by the first device 110. In a similar manner, the first device 110 may reserve a second retransmission resource 330 for a possible second retransmission of the data 140 and, although not shown in FIG. 3, more resources can be reserved by the first device 110 for more possible retransmissions analogously. The number of the reserved resources may be configurable.

For the first retransmission of the data 140, the second device 120 may also provide an ACK/NACK feedback at a time point T4. If the feedback for the first retransmission is again a NACK, the first device 110 may use the second retransmission resource 330 at a time point T5 to perform the second retransmission of the data 140. If the feedback for the first retransmission is an ACK, the first device 110 may release the second retransmission resource 330. More retransmissions of the data 140 and release of more reserved resources may be performed in a similar way.

In view of the relatively low probability of transmission failure of the data 140 (for example, 10% as mentioned), it might be disadvantageous for the first device 110 to always reserve a retransmission resource whenever it has data to be transmitted via a sidelink channel, which may leads to inefficient resource utilization of the resources in the resource pool 300.

Accordingly, referring back to FIG. 2, at block 220, after generating the data 140 to be transmitted to the second device 120 via the sidelink channel 115, the first device 110 determines whether a reservation criterion for reserving the retransmission resource 150 for a retransmission of the data 140 is satisfied. If the reservation criterion is satisfied, the first device 110 determines to reserve the retransmission resource 150 for a potential retransmission in future. Otherwise, the first device 110 does not reserve the retransmission resource 150, and can select a transmission resource for performing the retransmission of data 140 after receiving the NACK from the second device 120. In this way, the first device 110 does not always reserve a retransmission resource whenever there is data to be transmitted, but optionally reserves a retransmission resource based on the reservation criterion, so that unnecessary reservation by the first device 110 can be advantageously avoided.

In some embodiments, the first device 110 can be configured with one or more of various reservation criteria. For example, the first device 110 can use a quality of service (QoS) level to determine whether to reserve the retransmission resource 150. The QoS level herein may include a QoS level of the data 140 or a transmission QoS level of the data 140. The former may indicate a QoS requirement for the data 140 per se, such as packet latency or reliability requirements, or the like. The latter may indicate a QoS requirement for a transmission associated with the data 140. For example, a retransmission of the data 140 may have a higher QoS requirement than an initial retransmission of the data 140. In some embodiments, the QoS level can be derived from a higher layer configuration or a QoS parameter to be carried in sidelink control information (SCI) associated with the sidelink transmission.

Accordingly, if the QoS level of the data 140 exceeds a configurable threshold (also referred to as a first threshold), meaning that the data 140 has a high QoS requirement, then the first device 110 can reserve the retransmission resource 150. Otherwise, the first device 110 may not reserve the retransmission resource 150. Similarly, if the transmission QoS level of the data 140 exceeds a configurable threshold (also referred to as a second threshold), meaning that the transmission associates with the data 140 has a high QoS requirement, then the first device 110 can reserve the retransmission resource 150. Otherwise, the first device 110 may not reserve the retransmission resource 150. In some embodiments, the first and second thresholds can be a parameter from a higher layer (such as a data link layer or a network layer) or may be pre-configured.

Alternatively or additionally, the first device 110 may use a priority of the data 140 to determine whether to reserve the retransmission resource 150. In some embodiments, the priority of the data 140 can be derived from a higher layer configuration or a priority field to be carried in a SCI associated with the sidelink transmission. Thus, if the priority of the data 140 exceeds a configurable threshold (also referred to as a third threshold), meaning that the data 140 has high importance, then the first device 110 can reserve the retransmission resource 150. Otherwise, the first device 110 may not reserve the retransmission resource 150. In some embodiments, the third threshold can be a parameter from a higher layer or may be pre-configured.

Alternatively or additionally, the first device 110 may use available transmission power of the first device 110 to determine whether to reserve the retransmission resource 150. In one option, if the available transmission power of the first device 110 exceeds a configurable threshold (also referred to as a fourth threshold), meaning that the first device 110 has extra power to transmit additional information, then the first device 110 can reserve the retransmission resource 150. Otherwise, the first device 110 may not reserve the retransmission resource 150. In some embodiments, the fourth threshold can be a parameter from a higher layer or may be pre-configured.

As another option, if the available transmission power of the first device 110 is below a further configurable power threshold, meaning that the second device 120 has a greater probability of unsuccessfully receiving the data 140, then the first device 110 can reserve the retransmission resource 150. Otherwise, the first device 110 may not reserve the retransmission resource 150. In some embodiments, the further configurable power threshold can be a parameter from a higher layer or may be pre-configured.

Alternatively or additionally, the first device 110 may use a time interval associated with an available retransmission resource to determine whether to reserve the retransmission resource 150. In particular, referring to FIG. 3, if the time interval (also referred to a first time interval) between the time point T2 when the second device 120 is to transmit an ACK/NACK for the data 140 and the time point T3 of a beginning of an available retransmission resource 150 is shorter than a configurable threshold (also referred to as a fifth threshold), meaning that the retransmission of the data 140 would not leads to a large delay, then the first device 110 can reserve the retransmission resource 150. It is noted that although the time points T2 and T3 indicate the beginnings of the associated resource blocks as shown in FIG. 3, in other embodiments, the time points T2 and T3 may alternatively refer to the ends of the associated resource blocks.

Otherwise, if the first time interval is longer than the fifth threshold, the first device 110 may not reserve the retransmission resource 150. It is noted that in this event the first device 110 may be able to select an earlier transmission resource after receiving a NACK from the second device 120, since a transmission resource which is occupied when the first device 100 performs the reservation may be released after the first device 100 receives the NACK. In some embodiments, the fifth threshold can be a parameter from a higher layer or may be pre-configured.

Alternatively or additionally, the first device 110 may use a delay budget of the data 140 to determine whether to reserve the retransmission resource 150. In particular, referring to FIG. 3, if a delay budget of the data 140 exceeds a time interval (also referred to a second time interval) between the time point T0 when the data 140 is generated and the time point T3 of the beginning of the available retransmission resource 150, meaning that the delay associated with the retransmission of the data 140 is below its delay budget, then the first device 110 can reserve the retransmission resource 150. Otherwise, the first device 110 may not reserve the retransmission resource 150. It is noted that although the time point T3 indicates the beginning of the available retransmission resource 150 as shown in FIG. 3, in other embodiments, the time point T3 may alternatively refer to the end of the available retransmission resource 150.

In some other embodiments, the first device 110 may compare the delay budget with a configurable threshold (also referred to as a sixth threshold) to determine whether to reserve the retransmission resource 150. Accordingly, if the delay budget of the data 140 is below the sixth threshold, meaning that the data 140 is urgent data, then the first device 110 can reserve the retransmission resource 150. Otherwise, the first device 110 may not reserve the retransmission resource 150. In some embodiments, the sixth threshold can be a parameter from a higher layer or may be pre-configured.

Alternatively or additionally, the first device 110 may use a congestion level associated with the resource pool 300 to determine whether to reserve the retransmission resource 150. Accordingly, if the congestion level associated with the resource pool 300 exceeds a configurable threshold (also referred to as a seventh threshold), meaning that there is a high probability of collision in selecting an available retransmission resource if the reservation is not performed, then the first device 110 can reserve the retransmission resource 150. Otherwise, the first device 110 may not reserve the retransmission resource 150. In some embodiments, the seventh threshold can be a parameter from a higher layer or may be pre-configured. In some embodiments, the seventh threshold may be associated with the priority of the data 140, so as to ensure the retransmission resource 150 can be reserved if the data 140 has a high priority. For example, a lower seventh threshold can be configured for a TB with a higher priority.

Alternatively or additionally, the first device 110 may use a retransmission number to determine whether to reserve the retransmission resource 150. In particular, if the number of retransmissions of the data 140 is below a configurable threshold (also referred to as an eighth threshold), then the first device 110 can reserve the retransmission resource 150. Otherwise, the first device 110 may not reserve the retransmission resource 150. That is, the first device 110 can reserve resources for the first N retransmissions of the data 140. The number N can be pre-configured. In some embodiments, no reservation is performed for the last retransmission of the data 140.

In some embodiments, as depicted in FIG. 3, a position of the retransmission resource 150 in time domain may be after the time point T2 when the second device 120 is to transmit an ACK/NACK for the data 140. In other words, the time point T3 of the beginning of the retransmission resource 150 in time domain may be after the time point T2. In this way, useless reservation by the first device 110 can be effectively avoided, since the first device 110 is unable to perform a retransmission of the data 140 before receiving a NACK from the second device 120, and thus the first device 110 cannot use a transmission resource before the time point T2 in time domain to retransmit the data 140. Thus, the earliest available resource that can be reserved by the first device 110 may be after the time point T2 of the associated PSFCH, and can be determined according to a configuration of a period of the PSFCH and a slot index of the PSSCH.

Referring back to FIG. 2, at block 230, if the first device 110 determines that the reservation criterion is satisfied, the first device 110 transmits reservation information 160 to the further devices. The further devices include the second device 120 and the third device 130. The reservation information 160 indicates that the retransmission resource 150 is reserved by the first device 110, so that the further devices can select a transmission resource from the resource pool 300 to perform their sidelink transmissions in view of the fact that the retransmission resource 150 is reserved by the first device 110.

The first device 110 may transmit the reservation information 160 in any suitable manner. For example, the first device 110 may use new dedicated signaling to transmit the reservation information 160, without changing content and structure of existing signaling. As another example, the first device 110 can include the reservation information 160 in existing signaling for a sidelink communication, so as to take full advantage of existing signaling. In particular, the first device 110 may include the reservation information 160 in a SCI and transmit the SCI to the second device 120 as well as other devices. In one option, the SCI including the reservation information 160 may be a SCI (also referred to as a first SCI) of a previous transmission of the data 140. In another option, the SCI including the reservation information 160 may be a SCI (also referred to as a second SCI) for reserving a transmission resource for the previous transmission of the data 140.

In order to indicate positions of the retransmission resource 150 in time domain and frequency domain, the SCI including the reservation information 160 can further include a time position indicator and a frequency position indicator. The time position indicator indicates a position of the retransmission resource 150 in time domain, and the frequency position indicator indicates a position of the retransmission resource 150 in frequency domain. For example, a SCI of the initial transmission of the data 140 can indicate positions of the first retransmission resource 150 in time domain and frequency domain, a SCI of the first retransmission of the data 140 can indicate positions of the second retransmission resource 330 in time domain and frequency domain, and so on.

In other words, a retransmission resource may be indicated in the SCI associated with a previous transmission, and a SCI of the transmission resource may indicate a transmission resource for a next retransmission. This indicating approach may be termed as a chain manner, which can distribute the time position indicators and the frequency position indicators of all the reserved transmission resources to a plurality of the SCIs associated with the transmissions of the data 140, and thus equalizing signaling overheads in the SCIs.

As an example of this indicating approach in the chain manner, a flag field of feedback based retransmission resource reservation may be defined in a SCI to indicate whether there is retransmission reservation or not. In the SCI, when there is no retransmission reservation, the flag field can be set to 0, a time offset field can be padded with 0 in the tail of the SCI, and a frequency offset or frequency location field can also be padded with 0 in the tail of the SCI. Alternatively, when there is retransmission reservation, the flag field can be set to 1, the time offset field and the frequency offset or frequency location field can be defined in the tail of the SCI. The time offset field indicates an offset relative to the time slot index of the SCI, for example, it can be expressed in a number of slots or in a number of symbols. The frequency offset or frequency location field indicates an offset relative to the frequency position of the SCI, for example, it can be expressed in a number of sub-channels. Other devices may know whether there is retransmission reservation and the locations of the reserved resource after decoding the SCI.

As another example indicating approach, the SCI including the reservation information 160 may include a number indicator, a time position indicator, and a frequency position indicator. The number indicator indicates a number of retransmission resources for a plurality of retransmissions of the data 140, the time position indicator indicates a plurality of positions of the retransmission resources in time domain, and the frequency position indicator indicates a plurality of positions of the retransmission resources in frequency domain. In this way, the time position indicators and the frequency position indicators of all the reserved transmission resources can be included in one SCI, without affecting other SCIs associated with the transmissions of the data 140.

For example, a flag field of feedback based retransmission resource reservation can be defined in the SCI of the initial transmission or in the reservation SCI of the initial transmission, to indicate the number of reserved resources for retransmissions of the data 140. In the SCI, when there is no retransmission reservation, the flag field can be set to 0, a time offset field can be padded with 0 in the tail of the SCI, and a frequency offset or frequency location field can also be padded with 0 in the tail of the SCI. Alternatively, when there is retransmission reservation, the flag field indicates the number of retransmission resources, namely, the retransmission number of the data 140. A time offset field and a frequency offset or frequency location field can be defined in the tail of the SCI. The time offset field indicates offsets relative to a time slot index of each transmission, for example, expressed in a number of slots. The frequency offset or frequency location field indicates offsets relative to a frequency position of each transmission, for example, expressed in a number of sub-channels. Other devices may know whether there is retransmission reservation and the locations of the reserved resource after decoding the SCI.

As another example, the time offset field can indicate positions of all the reserved resources in time domain. For example, the time offset field may include all the time offset values of all the reserved resources relative to the SCI in time domain. The frequency offset or frequency location field can indicate positions of all the reserved resources in frequency domain. For example, the frequency offset or frequency location field may include all the frequency offset values of all the reserved resources relative to the SCI in frequency domain. It is to be understood that the specific fields and their specific values as described above are only examples, without suggesting any limitations as to the scope of the disclosure. In other embodiments, the SCI may have any suitable fields with any suitable values used as indicators.

In the above, some embodiments are described from a perspective of a transmitting device (for example, the first device 110) of a sidelink transmission. In the following, with reference to FIG. 4, some other embodiments will be described from a perspective of a receiving device (for example, the second device 120) of the sidelink transmission.

FIG. 4 shows another flowchart of an example method 400 in accordance with some embodiments of the present disclosure. In some embodiments, the method 400 can be implemented at a terminal device, such as the second device 120 as shown in FIG. 1. Additionally or alternatively, the method 400 can also be implemented at other communication devices not shown in FIG. 1. For the purpose of discussion, the method 400 will be described with reference to FIG. 1 as performed by the second device 120 without loss of generality.

At block 410, the second device 120 receives reservation information 160 from the first device 110. The reservation information 160 indicates that the retransmission resource 150 is reserved for a retransmission of the data 140 from the first device 110 to the second device 120 via the sidelink channel 115. As described, the retransmission resource 150 is comprised in the resource pool 300 for sidelink communications of the second device 120 and further devices. The further devices include the first device 110 and the third device 130.

At block 420, after receiving the reservation information 160 from the first device 110, the second device 120 determines availability of the retransmission resource 150 for a sidelink transmission from the second device 120 to at least one of the further devices. In other words, if the second device 120 is to perform a sidelink transmission to other devices (including the first device 110 and the third device 130) sharing the same resource pool 300, the second device 120 may need to determine whether the retransmission resource 150 indicated in the reservation information 160 is available for its own sidelink transmission or not, namely, whether the second device 120 can use this retransmission resource 150 reserved by the first device 110 to perform its own sidelink transmission.

In general, if the second device 120 can determine that the first device 110 is not to retransmit the data 140 using the retransmission resource 150, the second device 120 may determine the retransmission resource 150 as available for its own sidelink transmission. In contrast, if second device 120 can determine that the first device 110 needs to retransmit the data 140 using the retransmission resource 150, the second device 120 may determine the retransmission resource 150 as unavailable for its own sidelink transmission. In addition, if the second device 120 cannot know whether first device 110 needs to retransmit the data 140 using the retransmission resource 150, the second device 120 may also determine the retransmission resource 150 as unavailable for its own sidelink transmission.

In other words, in order to determine the availability of the retransmission resource 150, the second device 120 may need to know whether the first device 110 needs to use the retransmission resource 150 to retransmit the data 140, that is, whether the data 140 is successfully received by intended receiving device(s) of the data 140. To this end, the second device 120 can first determine whether the data 140 is transmitted via a groupcast transmission or a unicast transmission, since the determination by the second device 120 as to whether the data 140 needs to be retransmitted is different for these two transmission manners. In a groupcast transmission, the first device 110 transmits the data 140 to a group of devices including the second device 120, whereas in a unicast transmission, the first device 110 transmits the data 140 only to the second device 120.

In some embodiments, if the data 140 is transmitted via a groupcast transmission, the second device 120 may directly determine that the retransmission resource 150 is unavailable for its own sidelink transmission. That is, for a groupcast transmission of data 140, from a perspective of a receiving device, the reserved retransmission resource 150 may be considered as occupied by the first device 110 and cannot be selected for its own sidelink transmission, no matter the data 140 is successfully received and decoded by itself or not.

The reason is that the data 140 is transmitted to a group of devices in a groupcast transmission and that the second device 120 cannot know whether other receiving devices in the receiving group successfully received the data 140 or not, without monitoring ACK/NACK channels from the other receiving devices to the first device 110. Therefore, as a simply rule for the second device 120 to determine the availability of the retransmission resource 150, the second device 120 may consider the retransmission resource 150 as unavailable in a group transmission. In this way, the operations of the second device 120 can be greatly simplified.

Alternatively, in a groupcast transmission of the data 140, the second device 120 can determine whether to monitor the ACK/NACK channels from the other receiving devices to the first device 110, based on an ACK/NACK transmission mode of the groupcast transmission. For example, as described with reference to FIG. 1, the receiving devices of the groupcast transmission may employ one of two different ACK/NACK transmission modes for transmitting an ACK/NACK to the first device 110. The first ACK/NACK transmission mode may also be referred to as the option 1 for HARQ feedbacks, in which no signal in an ACK/NACK channel indicating a successful reception. The second ACK/NACK transmission mode may also be referred to as the option 2 for HARQ feedbacks, in which an ACK in an ACK/NACK channel indicating a successful reception.

If the option 1 is used by the receiving devices of the groupcast transmission, the second device 120 needs not to transmit an ACK in case the data 140 is successfully received by the second device 120. This means that, although a half-duplex operation is generally used by the second device 120 in sidelink communications, the second device 120 can monitor the PSFCHs from other receiving devices to the first device 110, to decide whether the retransmission resource 150 is available for its own sidelink transmission. According to a result of the monitoring, if the second device 120 detects no signal in any of the ACK/NACK channels, meaning that all the other receiving devices successfully receive the data 140, then the second device 120 can thus determine that the retransmission resource 150 is available for its own sidelink transmission, since the first device 110 does not need to retransmit the data 140 using the retransmission resource 150.

Otherwise, if the second device 120 detects a signal in any of the ACK/NACK channels, meaning that one or more of the other receiving devices do not successfully receive the data 140, then the second device 120 can thus determine that the retransmission resource 150 is unavailable for its own sidelink transmission, because the first device 110 needs to use the retransmission resource 150 to retransmit the data 140. In this manner, the second device 120 can increase the correctness in determining the availability of the retransmission resource 150, in the case that there is a possibility for the second device 120 to monitor the ACK/NACK channels of other receiving devices.

Similarly, if the data 140 is unsuccessfully received by the second device 140, meaning that the second device 140 needs to transmit a NACK in the PSFCH and thus has no chance to monitor the PSFCHs of other receiving devices due to the half-duplex restriction, then the second device 140 may also determine that the retransmission resource 150 is unavailable for the sidelink transmission, since the second device 120 cannot know whether other receiving devices receive the data 140 successfully. In addition, in this situation, the second device 120 can know that the data 140 needs to be retransmitted to itself, which also leads to a negative determination of the availability of the retransmission resource 150. In this way, the operations of the second device 120 can be simplified.

In contrast to a groupcast transmission, the determination of the availability of the retransmission resource 150 by the second device 120 may be much simpler in the case that the data 140 is transmitted via a unicast transmission, in which the second device 120 is the only intended receiving device of the data 140. Therefore, if the data 140 is successfully received by the second device 140, the second device 140 can determine that the retransmission resource 150 is available for its own sidelink transmission, that is, the retransmission resource 150 is released by the first device 110. Otherwise, if the data 140 is unsuccessfully received by the second device 140, the second device 140 may determine that the retransmission resource 150 is unavailable for its own sidelink transmission, since the retransmission resource 150 is to be used by the first device 110 to retransmit the data 140 to the second device 120. In this manner, the second device 120 can accurately determine the availability of the retransmission resource 150 in case of a unicast transmission.

At block 430, the second device 120 selects a transmission resource for its own sidelink transmission from the resource pool 300, based on the availability of the retransmission resource 150. More specifically, if the second device 120 determines the retransmission resource 150 as available, the second device 120 may consider the retransmission resource 150 as a candidate for the transmission resource for its own sidelink transmission, thus increasing resource utilization of the resource pool 300.

On the other hand, if the second device 120 determines the retransmission resource 150 as unavailable, the second device 120 may not consider the retransmission resource 150 as a candidate for the transmission resource for its own sidelink transmission, so as to avoid a potential transmission collision in the retransmission resource 150 with the first device 110. In this way, the second device 120 as a receiving device of the sidelink transmission from the first device 110 as a transmitting device can make use of a transmission resource released by the transmitting device.

Similarly, the first device 110 as the transmitting device of the data 140 may also select a transmission resource for another sidelink transmission from the resource pool 300, based on the availability of the retransmission resource 150. For example, if the first device 110 does not receive a NACK for the data 140 from the second device 120 (in the case of a unicast transmission), or does not receive a NACK for the data 140 from any of the intended receiving device (in the case of a groupcast transmission), the first device 110 does not need to retransmit the data 140 using the retransmission resource 150. In this event, the first device 110 can determine the retransmission resource 150 as available, and may thus consider the retransmission resource 150 as a candidate for a transmission resource for another sidelink transmission of the first device 110, thereby increasing resource utilization of the resource pool 300.

On the other hand, if the first device 110 receives a NACK for the data 140 from the second device 120 (in the case of a unicast transmission), or receives a NACK for the data 140 from any of the intended receiving device (in the case of a groupcast transmission), the first device 110 may need to retransmit the data 140 using the retransmission resource 150.

In this event, the first device 110 can determine the retransmission resource 150 as unavailable, and thus may not consider the retransmission resource 150 as a candidate for a transmission resource for another sidelink transmission of the first device 110.

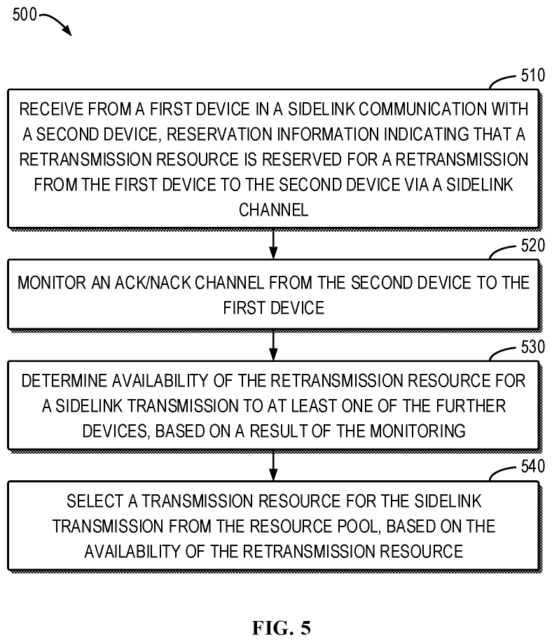

In the above, some embodiments are described from perspectives of a transmitting device (for example, the first device 110) and a receiving device (for example, the second device 120) of a sidelink transmission. In the following, with reference to FIG. 5, some other embodiments will be described from a perspective of a device (for example, the third device 130) other than a transmitting device and a receiving device of the sidelink transmission.

FIG. 5 shows a further flowchart of an example method 500 in accordance with some embodiments of the present disclosure. In some embodiments, the method 500 can be implemented at a terminal device, such as the third device 130 as shown in FIG. 1. Additionally or alternatively, the method 500 can also be implemented at other communication devices not shown in FIG. 1. For the purpose of discussion, the method 500 will be described with reference to FIG. 1 as performed by the third device 130 without loss of generality.

At block 510, the third device 130 receives the reservation information 160 from the first device 110, for example, via the sidelink channel 125. As described, the first device 110 is in a sidelink communication with the second device 120, for example, the first device 110 is to transmit the data 140 to the second device 120 via the sidelink channel 115. The reservation information 160 indicates that the retransmission resource 150 is reserved for a retransmission of the data 140 from the first device 110 to the second device 120 via the sidelink channel 115. As mentioned, the retransmission resource 150 is comprised in a resource pool 300 for sidelink communications of the third device 130 and further devices. The further devices include the first device 110 and the second device 120.

After receiving the reservation information 160 from the first device 110, the third device 130 may need to determine whether the retransmission resource 150 indicated in the reservation information 160 is available for a sidelink transmission from the third device 130 to the further devices including the first device 110 and the second device 120, namely, whether the third device 130 can use this retransmission resource 150 reserved by the first device 110 to perform its own sidelink transmission.

For this purpose, at block 520, the third device 130 monitors an ACK/NACK channel from the second device 120 to the first device 110, to determine whether the first device 110 is to use the retransmission resource 150 to retransmit the data 140. For example, the third device 130 may monitor the PSFCH of the associated PSSCH (for example, the prior PSSCH of the reserved retransmission) from the first device 110 to the second device 120, that is, the PSFCH of the second device 120.

In some embodiments, the monitoring behavior of the third device 130 can be configured or pre-configured by a higher layer. For example, the higher layer can configure whether the third device 130 monitors the ACK/NACK channel from the second device 120 to the first device 110. If the third device 130 is configured to monitor the ACK/NACK channel, the third device 130 may determine the availability of the retransmission resource 150 based on the result of the monitoring. If the third device 130 is not configured to monitor the ACK/NACK channel, the third device 130 may consider the retransmission resource 150 as unavailable, since the third device 130 has no information on whether the first device 110 is to use the retransmission resource 150 to retransmit the data 140.

In some other embodiments, the third device 130 may determine whether to monitor the ACK/NACK channel based on a predefined monitoring criterion. For example, before monitoring the ACK/NACK channel, the third device 130 may determine whether the monitoring criterion is satisfied. If the monitoring criterion is satisfied, the third device 130 can monitor the ACK/NACK channel and determine the availability of the retransmission resource 150 based on the result of the monitoring. Otherwise, the third device 130 may not monitor the ACK/NACK channel, and consider the retransmission resource 150 as unavailable, since the third device 130 does not know whether the first device 110 is to use the retransmission resource 150 to retransmit the data 140. In this way, unnecessary monitoring of the ACK/NACK channel by the third device 130 can be avoided.

In some embodiments, the third device 130 can be configured with one or more of various monitoring criteria. For example, the third device 130 can use a QoS level to determine whether to monitor the ACK/NACK channel. The QoS level may include a QoS level of the data of the third device 130 or a transmission QoS level of the data of the third device 130. The former may indicates a QoS requirement for the data per se of the third device 130, such as packet latency/reliability requirements. The latter may indicate a QoS requirement for a transmission associated with the data of the third device 130. In some embodiments, the QoS level can be derived from a higher layer configuration or the QoS parameter to be carried in a SCI.

Accordingly, if the QoS level of the data to be transmitted by the third device 130 exceeds a configurable threshold (also referred to as a ninth threshold), meaning that the data of the third device 130 has a high QoS requirement, then the third device 130 can monitor the ACK/NACK channel. Otherwise, the third device 130 may not monitor the ACK/NACK channel. Similarly, if the transmission QoS level of the data of the third device 130 exceeds a configurable threshold (also referred to as a tenth threshold), meaning that the transmission associates with the data of the third device 130 has a high QoS requirement, then the third device 130 can monitor the ACK/NACK channel. Otherwise, the third device 130 may not monitor the ACK/NACK channel. In some embodiments, the ninth and tenth thresholds can be a parameter from a higher layer or may be pre-configured.

Alternatively or additionally, the third device 130 may use a priority of the data of the third device 130 to determine whether to monitor the ACK/NACK channel. In some embodiments, the priority of the data of the third device 130 can be derived from a higher layer configuration or a priority field to be carried in a SCI. Thus, if the priority of the data of the third device 130 exceeds a configurable threshold (also referred to as an eleventh threshold), meaning that the data of the third device 130 has high importance, then the third device 130 can monitor the ACK/NACK channel. Otherwise, the third device 130 may not monitor the ACK/NACK channel. In some embodiments, the eleventh threshold can be a parameter from a higher layer or may be pre-configured.

As another option, the third device 130 can compare the priority of the data to be transmitted with the priority of the data 140. In this option, if the priority of the data of the third device 130 exceeds the priority of the data 140, meaning that the data of the third device 130 is more important than the data 140, then the third device 130 can monitor the ACK/NACK channel. Otherwise, the third device 130 may not monitor the ACK/NACK channel.

Alternatively or additionally, the third device 130 may use available transmission power of the third device 130 to determine whether to monitor the ACK/NACK channel.

Thus, if the available transmission power of the third device 130 exceeds a configurable threshold (also referred to as a twelfth threshold), meaning that third device 130 has extra power to monitor the ACK/NACK channel, then the third device 130 can monitor the ACK/NACK channel. Otherwise, the third device 130 may not monitor the ACK/NACK channel. In some embodiments, the twelfth threshold can be a parameter from a higher layer or may be pre-configured.

Alternatively or additionally, the third device 130 may use a congestion level associated with the resource pool 300 to determine whether to monitor the ACK/NACK channel. Accordingly, if the congestion level associated with the resource pool 300 exceeds a configurable threshold (also referred to as a thirteenth threshold), meaning that there may be a small number of available resources for the sidelink transmission of the third device 130, then the third device 130 can monitor the ACK/NACK channel. Otherwise, the third device 130 may not monitor the ACK/NACK channel. In some embodiments, the thirteenth threshold can be a parameter from a higher layer or may be pre-configured. In addition, the thirteenth threshold may be associated with the priority of the data of the third device 130. For example, a lower thirteenth threshold can be configured for a TB with a higher priority.

Alternatively or additionally, the third device 130 may use a delay budget of the data of its own sidelink transmission to determine whether to monitor the ACK/NACK channel. In particular, if the delay budget of the data of the third device 130 is below a configurable threshold (also referred to as a fourteenth threshold), meaning that the data of the third device 130 is urgent data, then the third device 130 can monitor the ACK/NACK channel. Otherwise, the third device 130 may not monitor the ACK/NACK channel. In some embodiments, the fourteenth threshold can be a parameter from a higher layer or may be pre-configured.

At block 530, based on a result of the monitoring, the third device 130 determines availability of the retransmission resource 150 for a sidelink transmission to at least one of the further devices sharing the resource pool 300. Similar to the case discussed for the second device 120, the third device 130 can first determine whether the data 140 is transmitted via a groupcast transmission or a unicast transmission, since the determination by the third device 130 as to whether the data 140 needs to be retransmitted is different for these two transmission manners.

If the sidelink communication between the first device 110 and the second device 120 includes a unicast transmission, the data 140 is only transmitted to the second device 120. In this event, if the third device 130 detects an ACK in the ACK/NACK channel from the second device 120 to the first device 110, the third device 130 can determine that the retransmission resource 150 is available for its own sidelink transmission. It is noted that an ACK is represented by no signal in the ACK/NACK channel in the first ACK/NACK transmission mode, that is, the option 1 for HARQ feedbacks. If the third device 130 detects a NACK in the ACK/NACK channel from the second device 120 to the first device 110, the third device 130 can determine that the retransmission resource 150 is unavailable for its own sidelink transmission. In this way, the third device 130 can accurately determine the availability of the retransmission resource 150 in the case that the data 140 is transmitted via a unicast transmission.

If the sidelink communication between the first device 110 and the second device 120 includes a groupcast transmission, the data 140 is transmitted to a group of intended receiving devices including the second device 120. In this event, the third device 130 may need to further determine which ACK/NACK transmission mode is used for the groupcast transmission, since the monitoring manner may be different for different ACK/NACK transmission modes.

If the first ACK/NACK transmission mode is used for the groupcast transmission, the receiving devices of the groupcast transmission transmit no signal to indicate a successful reception. In this event, if the third device 130 detects no signal in any of ACK/NACK channels from the receiving devices to the first device 110, meaning that all the receiving devices receive the data 140 successfully, then the third device 130 can determine that the retransmission resource is available for its own sidelink transmission. If the third device 130 detects a signal in any of the ACK/NACK channels, meaning that at least one of the receiving devices fails to successfully receive the data 140, then the third device 130 can determine that the retransmission resource is unavailable for its own sidelink transmission. In this way, the third device 130 can accurately determine the availability of the retransmission resource 150 in the case that the data 140 is transmitted via a groupcast transmission and the first ACK/NACK transmission mode is used for the groupcast transmission.

If the second ACK/NACK transmission mode is used for the groupcast transmission, the receiving devices of the groupcast transmission transmit an ACK to indicate a successful reception. In this event, each of the receiving devices may use its identifier to scramble its ACK/NACK feedback, such that the first device 110 can distinguish ACK/NACK feedbacks from different receiving devices. Therefore, the third device 130 can decode the ACK/NACK channels from the receiving devices to the first device 110 using identifiers of the receiving devices. For example, the third device 130 can be pre-configured or informed via radio resource control (RRC) signaling with all the identifiers of the destination devices in the groupcast transmission. Then, the third device 130 can use each of the identifiers as a scrambled sequence to decode each of the PSFCHs from the receiving devices to the first device 110.

If the third device 130 detects no NACK in any of the ACK/NACK channels, meaning that all the receiving devices receive the data 140 successfully, then the third device 130 can determine that the retransmission resource 150 is available for its own sidelink transmission. If the third device 130 detects a NACK in any of the ACK/NACK channels, meaning that a receiving device fails to successfully receive the data 140, then the third device 130 can determine that the retransmission resource 150 is unavailable for the sidelink transmission. In this way, the third device 130 can accurately determine the availability of the retransmission resource 150 in the case that the data 140 is transmitted via a groupcast transmission and the second ACK/NACK transmission mode is used for the groupcast transmission.

At block 540, based on the availability of the retransmission resource 150, the third device 130 selects a transmission resource from the resource pool 300 for its own sidelink transmission from the third device 130 to the further devices including the first device 110 and the second device 120. More specifically, if the third device 130 determines the retransmission resource 150 as available, the third device 130 may consider the retransmission resource 150 as a candidate for the transmission resource for its own sidelink transmission, thus increasing resource utilization of the resource pool 300.

On the other hand, if the third device 130 determines the retransmission resource 150 as unavailable, the third device 130 may not consider the retransmission resource 150 as a candidate for the transmission resource for its own sidelink transmission, so as to avoid a potential transmission collision in the retransmission resource 150 with the first device 110. In this way, the third device 130 other than a transmitting device and a receiving device of the sidelink transmission can make use of the resources released by the transmitting device.

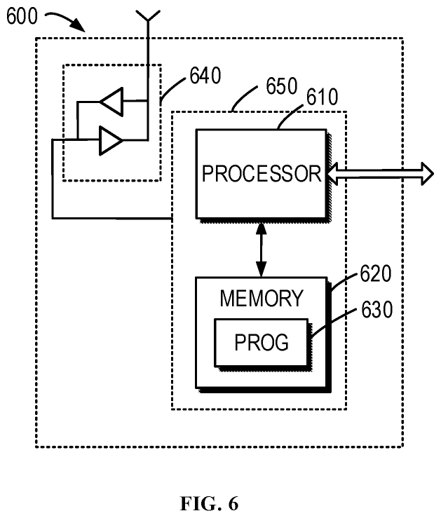

FIG. 6 is a simplified block diagram of a device 600 that is suitable for implementing some embodiments of the present disclosure. The device 600 can be considered as a further example embodiment of the first device 110, the second device 120, the third device 130, and the fourth device 105 as shown in FIG. 1. Accordingly, the device 600 can be implemented at or as at least a part of the first device 110, the second device 120, the third device 130, and the fourth device 105.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 620 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 630 is assumed to include program instructions that, when executed by the associated processor 610, enable the device 600 to operate in accordance with the embodiments of the present disclosure, as discussed herein with reference to FIGS. 2, 4, and 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2, 4, and 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-22. (canceled)

23. A method performed by a terminal device, comprising:
transmitting sidelink control information (SCI) comprising a time position indicator,
wherein the time position indicator indicates a time offset of at least one second resource for physical sidelink shared channel (PSSCH) transmission with respect to a time slot index of the SCI, wherein a first resource is in a slot where the SCI was received.

24. The method of claim 23, wherein the at least one second resource is at least one reserved resource for the PSSCH transmission.

25. The method of claim 24, wherein the at least one reserved resource is at least one retransmission resource for the PSSCH transmission.

26. The method of claim 25, wherein the at least one second resource comprises a third retransmission resource for the PSSCH transmission.

27. The method of claim 26, further comprising: determining a minimum time gap between the third retransmission resource and the first resource based on a period of physical sidelink feedback channel (PSFCH) and a slot index of the PSSCH transmission of the first resource.

28. The method of claim 25, wherein the at least one second resource comprises a fourth retransmission resource and a fifth retransmission resource for the PSSCH transmission.

29. A method performed by a terminal device, comprising:
receiving sidelink control information (SCI) comprising a time position indicator,
wherein the time position indicator indicates a time offset of at least one second resource for physical sidelink shared channel (PSSCH) transmission with respect to a time slot index of the SCI, wherein a first resource is in a slot where the SCI was received.

30. The method of claim 29, wherein the at least one second resource is at least one reserved resource for the PSSCH transmission.

31. The method of claim 30, wherein the at least one reserved resource is at least one retransmission resource for the PSSCH transmission.

32. The method of claim 31, wherein the at least one second resource comprises a third retransmission resource for the PSSCH transmission.

33. The method of claim 32, wherein a minimum time gap between the third retransmission resource and the first resource is determined based on a period of physical sidelink feedback channel (PSFCH) and a slot index of the PSSCH transmission of the first resource.

34. The method of claim 31, wherein the at least one second resource comprises a fourth retransmission resource and a fifth retransmission resource for the PSSCH transmission.

35. A terminal device, comprising:
a processor configured to:
transmit sidelink control information (SCI) comprising a time position indicator,
wherein the time position indicator indicates a time offset of at least one second resource for physical sidelink shared channel (PSSCH) transmission with respect to a time slot index of the SCI, wherein a first resource is in a slot where the SCI was received.

36. The terminal device of claim 35, wherein the at least one second resource is at least one reserved resource for the PSSCH transmission.

37. The terminal device of claim 36, wherein the at least one reserved resource is at least one retransmission resource for the PSSCH transmission.

38. The terminal device of claim 37, wherein the at least one second resource comprises a third retransmission resource for the PSSCH transmission.

39. The terminal device of claim 38, wherein the processor is further configured to:
determine a minimum time gap between the third retransmission resource and the first resource based on a period of physical sidelink feedback channel (PSFCH) and a slot index of the PSSCH transmission of the first resource.

40. The terminal device of claim 37, wherein the at least one second resource comprises a fourth retransmission resource and a fifth retransmission resource for the PSSCH transmission.
